(19) United States
(12) Patent Application Publication
(10) Pub. No.: US 2026/0015882 A1
(43) Pub. Date: Jan. 15, 2026

(54) TELESCOPIC FLAGPOLE

(71) Applicant: Chieh-Jen Hsiao, Taichung City (TW)

(72) Inventor: Hsuan-Sen Shiao, Taichung City (TW)

(73) Assignee: Chieh-Jen Hsiao, Taichung City (TW)

(21) Appl. No.: 18/902,064

(22) Filed: Sep. 30, 2024

(30) Foreign Application Priority Data
Jul. 15, 2024 (TW) 113207568

(51) Int. Cl. E04H 12/18; F16B 7/10

(52) U.S. Cl. CPC E04H 12/182; F16B 7/105

(57) ABSTRACT

A telescopic flagpole includes tubular members. A resistance member is disposed between and abuts against a respective adjacent pair of the tubular members. A resilient fastening mechanism is mounted to a lower end portion of a respective tubular member, and includes a fastening protrusion. When the telescopic flagpole is in a retracted state, the fastening protrusion abuts against an inner surface of an outer one of the respective adjacent pair of the tubular members. When the telescopic flagpole is in a fixed state, the resistance member is disposed between and abuts against the lower end portion of one of the respective adjacent pair of the tubular members and a upper end portion of another one of the respective adjacent pair of the tubular members, and the fastening protrusion protrudes outwardly from an upper through hole of the another one of the respective adjacent pair of the tubular members.

### CROSS-REFERENCE TO RELATED APPLICATION

This application claims priority to Taiwanese Utility Model patent application No. 113207568, filed on Jul. 15, 2024, the entire disclosure of which is incorporated by reference herein.

### FIELD

The disclosure relates to a flagpole, and more particularly to a telescopic flagpole

### BACKGROUND

A conventional telescopic flagpole includes a plurality of tubular members and a plurality of resilient fastening units. The tubular members are telescopically connected to each other, and each of the tubular members has a through hole. Each of the resilient fastening units is disposed between a respective adjacent pair of the tubular members, and includes a fastening protrusion. The fastening protrusion of each of the resilient fastening units is disposed on a lower end of a corresponding tubular member of the respective adjacent pair of the tubular members. When the conventional telescopic flagpole is telescopically extended, the fastening protrusion of each of the resilient fastening units extends through the through hole of the other tubular member of the respective adjacent pair of the tubular members so as to prevent the telescopic flagpole from being retracted.

When the conventional telescopic flagpole is telescopically extended or retracted, due to the weight and length of each of the tubular members, the tubular members are likely to quickly slide relative to each other. As a result, when the conventional telescopic flagpole is telescopically extended, it may be difficult to position the fastening protrusions to the through holes. When the conventional telescopic flagpole is telescopically retracted, the fastening protrusions may be damaged by hit of the other tubular member of the respective adjacent pair of the tubular members.

### SUMMARY

Therefore, an object of the disclosure is to provide a telescopic flagpole that can alleviate at least one of the drawbacks of the prior art.

According to the disclosure, the telescopic pole includes at least two tubular members and at least one fastening unit.

The tubular members surround an axis that is substantially vertical, and are telescopically connected to each other. Each of the at least two tubular members has a lower end portion and an upper end portion opposite to the lower end portion. The lower end portion of an outermost one of the at least two tubular members is designated as a flagpole bottom end portion of the telescopic flagpole. The lower end portion of each of a remainder of the at least two tubular members is designated as a general lower end portion. The upper end portion of an innermost one of the at least two tubular members is designated as a flagpole top end portion of the telescopic flagpole. The upper end portion of each of the remainder of the at least two tubular members is designated as a general upper end portion and is formed with an upper through hole that extends perpendicularly to the axis.

The least one fastening unit each is disposed between a respective adjacent pair of the at least two tubular members, and includes a resistance member and a resilient fastening mechanism. The resistance member is disposed between and abuts against the respective adjacent pair of the at least two tubular members to increase friction between the respective adjacent pair of the at least two tubular members. The resilient fastening mechanism is mounted to a respective general lower end portion, and includes a fastening protrusion being resiliently and radially movable.

The telescopic flagpole is convertible between a retracted state and a fixed state.

When the telescopic flagpole is in the retracted state, the fastening protrusion of each of the at least one fastening unit resiliently abuts against an inner surface of an outer one of the respective adjacent pair of the at least two tubular members.

When the telescopic flagpole is in the fixed state, the resistance member of each of the at least one fastening unit is disposed between and abuts against the general lower end portion of one of the respective adjacent pair of the at least two tubular members and the general upper end portion of another one of the respective adjacent pair of the at least two tubular members, and the fastening protrusion of each of the at least one fastening unit protrudes outwardly from the upper through hole of the general upper end portion of the another one of the respective adjacent pair of the at least two tubular members.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a telescopic flagpole according a first embodiment of the disclosure, which is in a retracted position.

FIG. 2 is a fragmentary schematic sectional view of the first embodiment illustrating the telescopic flagpole in the retracted position.

FIG. 3 is a fragmentary perspective view of the first embodiment illustrating a tubular member and a fastening unit of the telescopic flagpole.

FIG. 4 is a sectional view taken along line IV-IV of FIG. 2.

FIG. 5 is a fragmentary perspective view of the first embodiment illustrating a blocking member and an outermost tubular member of the telescopic flagpole.

FIG. 6 is a fragmentary enlarged view of FIG. 2.

FIG. 7 is a fragmentary sectional view of the first embodiment illustrating outer tubular members, resistance members, and resilient fastening mechanisms of the telescopic flagpole when the telescopic flagpole is in a fixed position.

FIG. 8 is a fragmentary sectional view of the first embodiment illustrating inner tubular members, resistance members, and resilient fastening mechanisms of the telescopic flagpole when the telescopic flagpole is in the fixed position.

FIG. 9 is an enlarged sectional view of part A of FIG. 7.

FIG. 10 is a fragmentary perspective view of the telescopic flagpole according to a second embodiment of the disclosure illustrating the resistance member, the resilient fastening mechanism, and the respective tubular member.

FIG. 11 is a fragmentary sectional view of the second embodiment illustrating the telescopic flagpole in the fixed position.

FIG. 12 is a fragmentary perspective view of the telescopic flagpole according to a third embodiment of the disclosure illustrating the resistance member, the resilient fastening mechanism, and the respective tubular member.

FIG. 13 is a fragmentary sectional view of the third embodiment illustrating the telescopic flagpole in the fixed position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

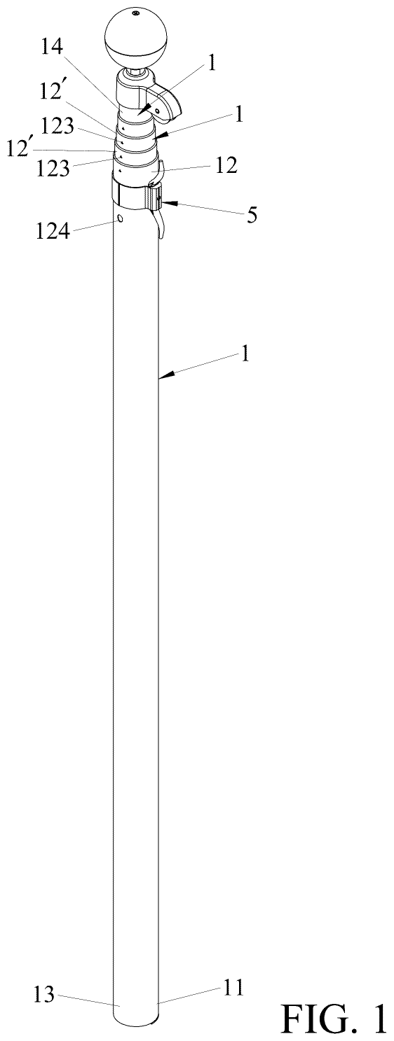

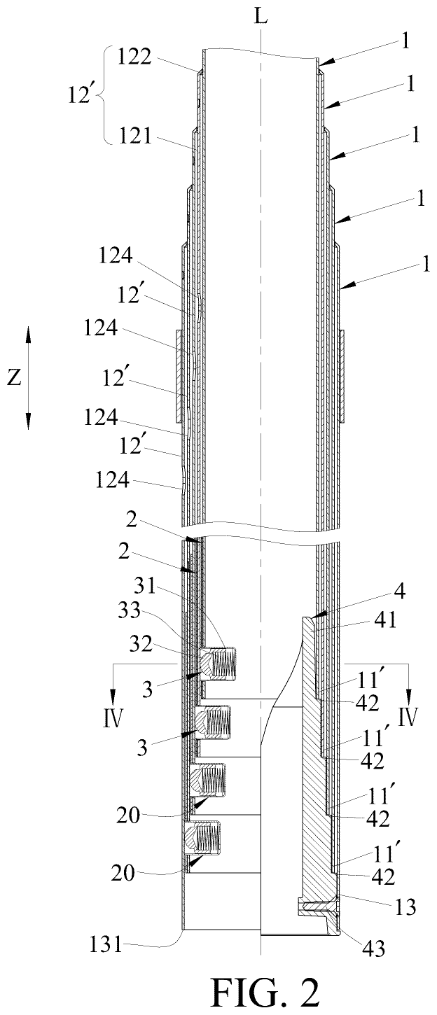

FIGS. 1 and 2 illustrate a telescopic flagpole according to a first embodiment of the disclosure. The telescopic flagpole of the disclosure includes a plurality of tubular members 1, a plurality of fastening units 20, a blocking member 4, and a halyard cleat 5.

The tubular members 1 surround an axis (L) that is substantially vertical, and are telescopically connected to each other. For each of adjacent pairs of the tubular members 1, the tubular members 1 are movable relative to each other along a vertical direction (Z), and are rotatable relative to each other about the axis (L). In this embodiment, each of the tubular members 1 is made of a metal material. The number of the tubular members 1 is, but not limited to, five. In other variant embodiments, the number of the tubular members 1 may be two, three, four or more than six. The vertical direction (Z) and the axis (L) are parallel to each other.

Each of the tubular members 1 has a lower end portion 11 and an upper end portion 12 opposite to the lower end portion 11. For clarification, the lower end portion 11 of an outermost one of the tubular members 1 is designated as a flagpole bottom end portion 13 of the telescopic flagpole. The lower end portion 11 of each of the remainder of the tubular members 1 is designated as a general lower end portion 11′. The upper end portion 12 of an innermost one of the tubular members 1 is designated as a flagpole top end portion 14 of the telescopic flagpole. The upper end portion 12 of each of the remainder of the tubular members 1 is designated as a general upper end portion 12′.

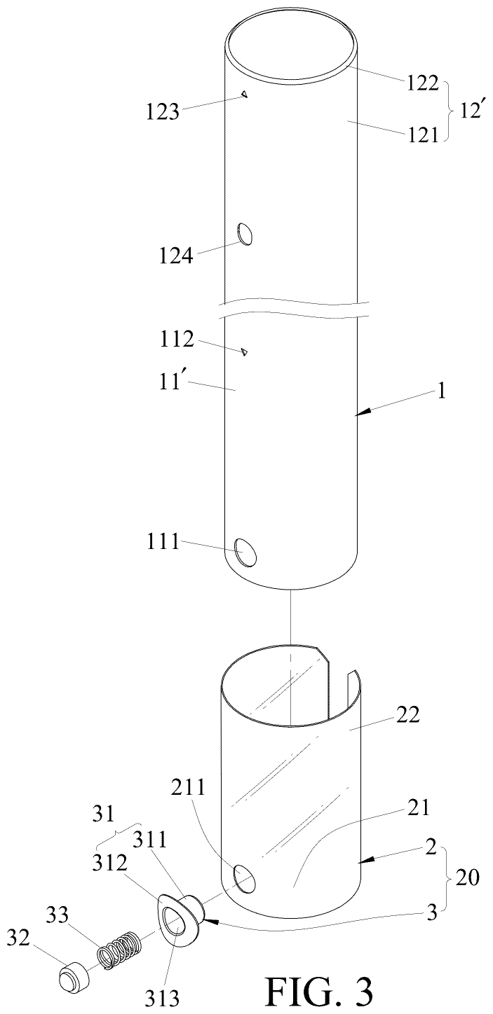

Referring to FIG. 3 in combination with FIG. 2, each general lower end portion 11′ is formed with a lower through hole 111 extending perpendicularly to the axis (L). An outer surface of each general lower end portion 11′ is formed with a first external anchoring index 112 that is disposed above the lower through hole 111 and that is configured as an inverted triangular recess.

Each general upper end portion 12′ has a tube segment 121 that is formed with an upper through hole 124, and an open segment 122 that is connected to a top end of the tube segment 121 and that has an internal width gradually decreases upwardly. The upper through hole 124 extends perpendicularly to the axis (L). An outer surface of each general upper end portion 12′ is formed with a second external anchoring index 123 that is disposed above the upper through hole 124 and that is configured as a triangular recess.

The flagpole bottom end portion 13 has a bottom end surface 131 (as shown in FIG. 2). The flagpole top end portion 14 (as shown in FIG. 1) is adapted for placement of a flag (not shown).

Each of the fastening units 20 is disposed between a respective adjacent pair of the tubular members 1. In this embodiment, the number of the fastening units 20, the number of the general lower end portions 11′, and the number of the general upper end portions 12′ are identical to each other and equal to the number of the tubular members 1 minus one. For example, when the number of the tubular members 1 is three, the number of the general upper end portions 12′ is two, the number of the general lower end portions 11′ is two, and the number of the fastening units 20 is two. In this embodiment, the number of the fastening units 20 is, but not limited to, four. In other variant embodiments, to correspond to variations of the number of the tubular members 1, the number of the fastening units 20 may vary. The number of the fastening units 20 may also be one, two, three, or more than five.

Specifically, the fastening units 20 are respectively connected to the general lower end portions 11′ of the tubular members 1. Each of the fastening units 20 includes a resistance member 2 and a resilient fastening mechanism 3. The resistance member 2 is disposed between and abuts against the respective adjacent pair of the tubular members 1. In this embodiment, the resistance member 2 of each of the fastening units 20 is secured on a respective general lower end portion 11′ of one of the respective adjacent pair of the tubular members 1. The resilient fastening mechanism 3 is mounted to the respective general lower end portion 11′.

For convenience of description, it is exemplified that one of the fastening units 20 is disposed between a respective adjacent pair of the tubular members 1.

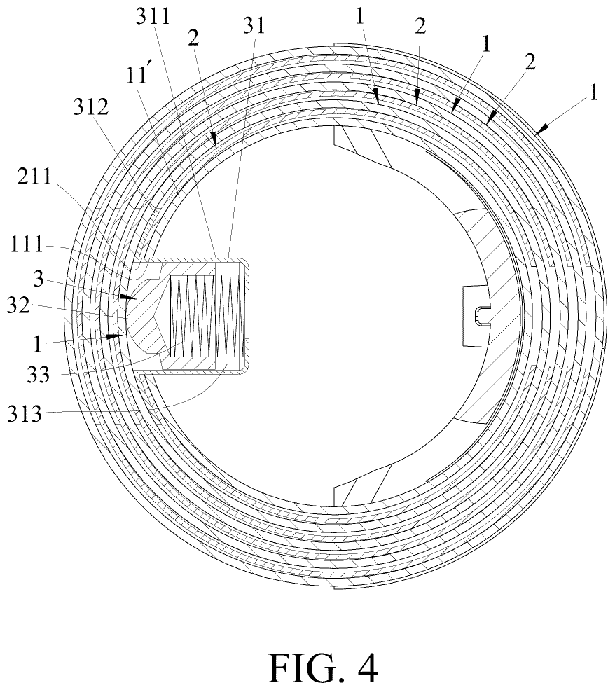

Referring to FIG. 4 in combination with FIGS. 2 and 3, the resistance member 2 of each of the fastening units 20 has a C-shaped cross section along a direction perpendicular to the vertical direction (Z). The resistance member 2 of each of the fastening units 20 partially surrounds an inner one of the respective adjacent pair of the tubular members 1, and resiliently abuts against the respective adjacent pair of the tubular members 1. As shown in FIGS. 3 and 4, the resistance member 2 of each of the fastening units 20 has a surrounding portion and two free end portions extending respectively from two opposite ends of the surrounding portion. For the resistance member 2 of each of the fastening units 20, the surrounding portion surrounds and is attached to the inner tubular member 1 of the respective adjacent pair of the tubular members 1, and the free end portions abut against the other tubular member 1 of the respective adjacent tubular members 1. As shown in FIGS. 2 and 3, the resistance member 2 has a lower resistance portion 21 and an upper resistance portion 22 opposite to the lower resistance portion 21 along the axis (L) and the vertical direction (Z). The lower resistance portion 21 has an open hole 211 aligned with the lower through hole 111 of a respective general lower end portion 11′. In this embodiment, the resistance member 2 is made of a plastic material. After being bent, the resistance member 2 is inserted between the respective adjacent pair of the tubular members 1, thereby resiliently abutting against the respective adjacent pair of the tubular members 1 to increase friction between the respective adjacent pair of the tubular members 1. In other variant embodiments, the resistance member 2 is bendable and is made of a resilient material.

The resilient fastening mechanism 3 of each of the fastening units 20 includes a fastening body 31, a fastening protrusion 32, and a resilient member 33. The fastening body 31 is mounted to the respective general lower end portion 11′ and extends through the lower through hole 111 of the respective general lower end portion 11′ and the open hole 211 of the resistance member 2. The fastening protrusion 32 is resiliently and radially movable relative to the respective general lower end portion 11′ and is movably connected to the fastening body 31. The resilient member 33 is disposed between the fastening body 31 and the fastening protrusion 32. Each of the fastening body 31 and the fastening protrusion 32 is made of a metal material.

The fastening body 31 has a casing portion 311 and an abutment portion 312. The casing portion 311 extends through the lower through hole 111 of the respective general lower end portion 11′ and the open hole 211 of the resistance member 2, defines a receiving space 313, and has a casing open end and a casing close end opposite to the casing open end. The abutment portion 312 is connected to the casing open end of the casing portion 311 and abuts against the resistance member 2. The resilient member 33 is disposed in the receiving space 313, and abuts against the casing close end of the casing portion 311. In this embodiment, the resilient member 33 is a spiral spring. By virtue of the resilient member 33, the fastening protrusion 32 is resiliently urged to move away from the casing close end of the casing portion 311. In addition, the abutment portion 312 is in an annular plate form and abuts against the lower resistance portion 21 of the resistance member 2 so as to fix the resistance member 2 to the respective general lower end portion 11′.

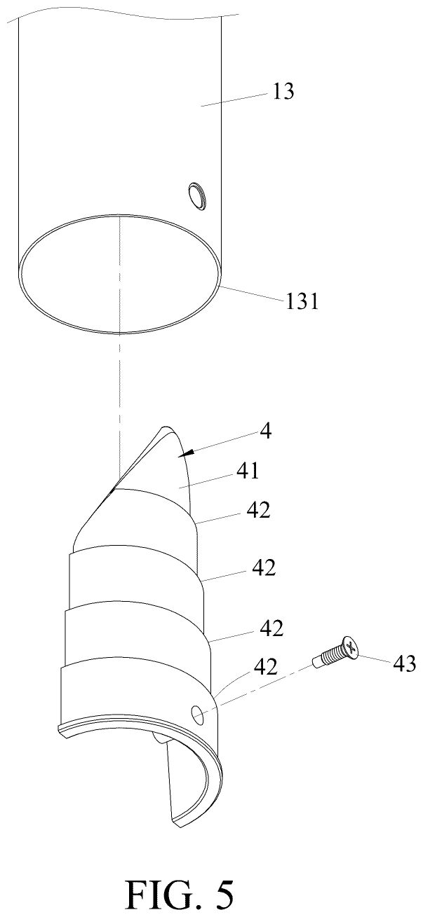

Referring to FIG. 5 in combination with FIG. 2, the blocking member 4 is disposed in the flagpole bottom end portion 13. The blocking member 4 is arc shaped that has an outer contour in conformity with an inner contour of the flagpole bottom end portion 13. The blocking member 4 has a main body portion 41 and a plurality of blocking portions 42 that extend from the main body portion 41 away from the axis (L). A screw 43 extends through the flagpole bottom end portion 13 and a bottom end of the blocking member 4, thereby fastening the blocking member 4 to the flagpole bottom end portion 13. In this embodiment, the number of the blocking portions 42 is equal to the number of the lower tubular portions 11′. Projections of each of the blocking portions 42 on an imaginary plane coplanar with the bottom end surface 131 respectively overlap projections of the general lower end portions 11′ on the imaginary plane. The blocking portions 42 of the blocking member 4 are arranged in a stairstep configuration. A distance between a lower one of the blocking portions 42 and the axis (L) is greater than a distance between an upper one of the blocking portions 42 and the axis (L).

Referring back to FIG. 1, the halyard cleat 5 is secured on the outermost one of the tubular members 1 for a rope (not shown) to be wound thereon.

The telescopic flagpole is convertible between a retracted state and a fixed state.

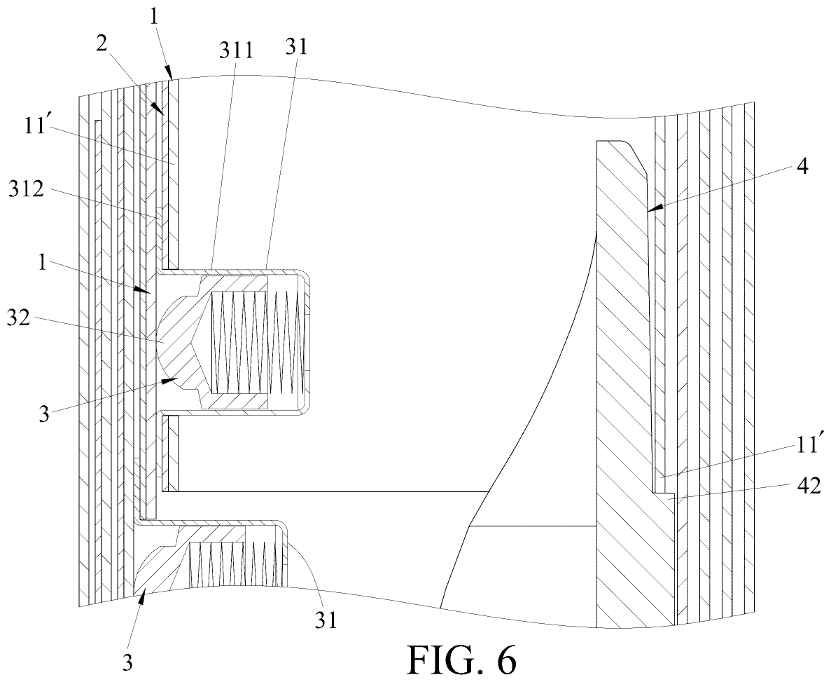

Referring to FIG. 6 in combination with FIG. 2, when the telescopic flagpole of the disclosure is in the retracted state, the fastening protrusion 32 of each of the fastening units 20 resiliently abuts against an inner surface of an outer one of the respective adjacent pair of the tubular members 1, and each general lower end portion 11′ abuts against the blocking member 4 and is spaced apart from the bottom end surface 131. Because the number of the blocking portions 42 is equal to the number of the lower tubular portions 11′, the general lower end portions 11′ respectively abut against the blocking portions 42 when the telescopic flagpole is in the retracted state. In a variant embodiment, there are two of the tubular members 1 in cooperation with only one fastening unit 20. In such a variant embodiment, when the telescopic flagpole of the disclosure is in the retracted state, the general lower end portion 11′ of the inner one of the two tubular members 1 may abut against a corresponding one of the blocking portions 42 and be spaced apart from the bottom end surface 131.

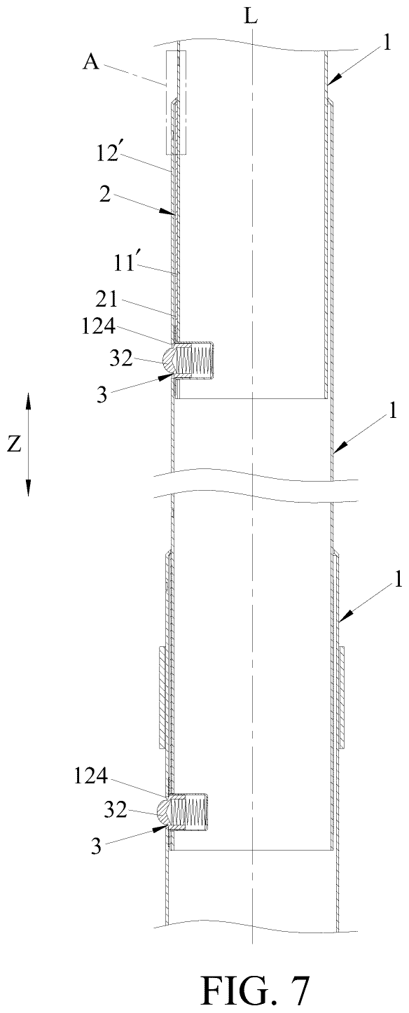

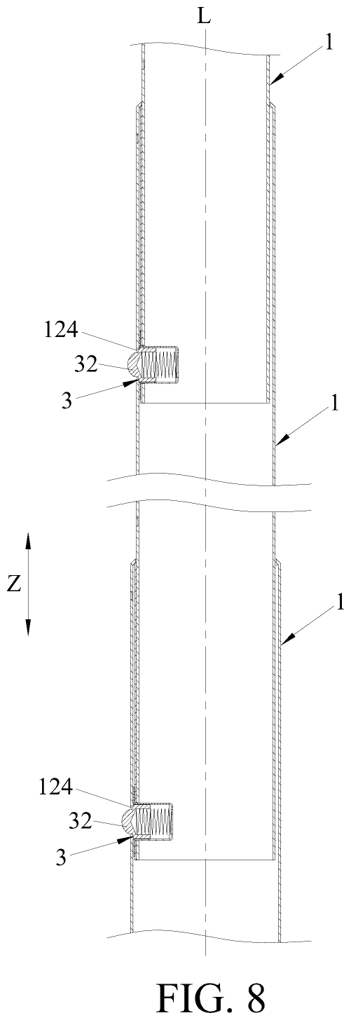

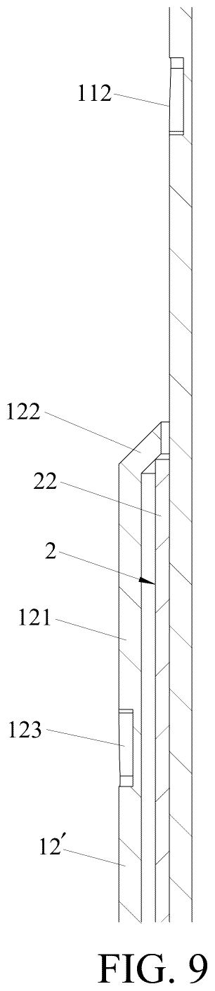

Referring to FIGS. 7 to 9, when the telescopic flagpole is in the fixed state, for each adjacent pair of the tubular members 1, the first external anchoring index 112 of one of the adjacent pair of the tubular members 1 and the second anchoring index 123 of another one of the adjacent pair of the tubular member 1 are substantially aligned with each other in a direction of the axis (L). Furthermore, when the telescopic flagpole is in the fixed state, the resistance member 2 of each of the fastening units 20 is disposed between and abuts against the general lower end portion 11′ of one of the respective adjacent pair of the tubular members 1 and the general upper end portion 12′ of another one of the respective adjacent pair of the tubular members 1, and the fastening protrusion 32 of each of the fastening units 20 protrudes outwardly from the upper through hole 124 of the general upper end portion 12′ of the another one of the respective adjacent pair of the tubular members 1. As a result, the tubular members 1 of each of the respective adjacent pairs of the tubular members 1 are immovable relative to each other along the vertical direction (Z) and about the axis (L). Specifically in this embodiment, when the telescopic flagpole is in the fixed state, the lower resistance portion 21 of the resistance member 2 of each of the fastening units 20 abuts against the general lower end portion 11′ of the one of the respective adjacent pair of the tubular members 1, and the upper resistance portion 22 of the resistance member 2 of each of the fastening units 20 abuts against the open segment 122 of the general upper end portion 12′ of the other one of the respective adjacent pair of the tubular members 1.

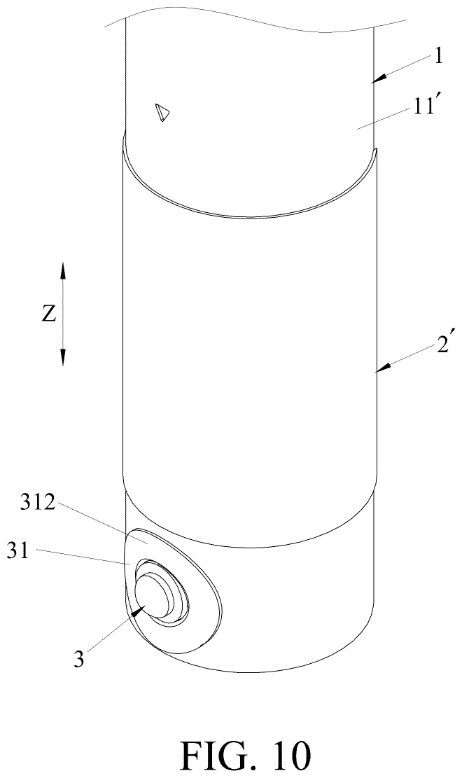

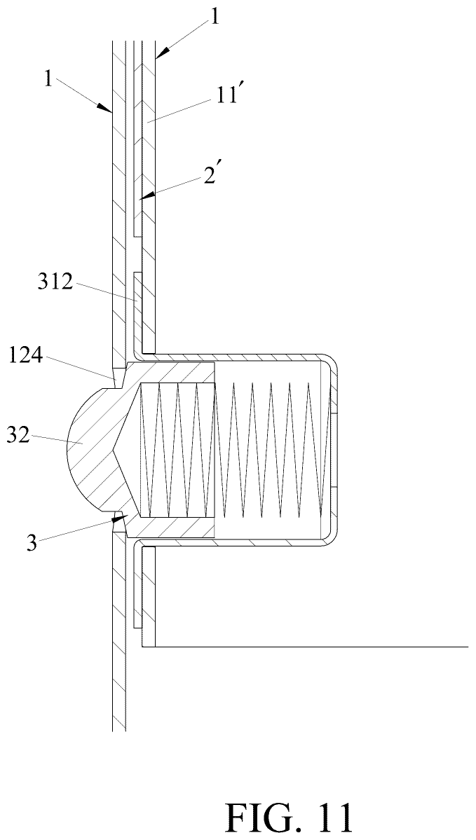

FIGS. 10 and 11 illustrate a telescopic flagpole according to a second embodiment of the disclosure, which has a structure generally slimier to that of the first embodiment. However, in this embodiment, the resistance member 2′ of each of the fastening units 20 is shortened in length along the vertical direction (Z). For each of the fastening units 20, the resistance member 2′ is disposed above the resilient fastening mechanism 3 and adhesively fixed to the respective tubular member 1 of the adjacent pair of the tubular members 1. The abutment portion 312 of the fastening body 31 is directly mounted to the respective general lower end portion 11′ and is spaced apart from an outer one of the respective adjacent pair of the tubular members 1. As a result, when the tubular members 1 of the adjacent pair of the tubular members 1 are moved or rotated relative to each other, noises generated by a frictional contact between the abutment portion 312 of the fastening body 31 and the outer one of the respective adjacent pair of the tubular members 1 are prevented, and abrasions of the abutment portion 312 of the fastening body 31 resulting in a reduction of service life is prevented.

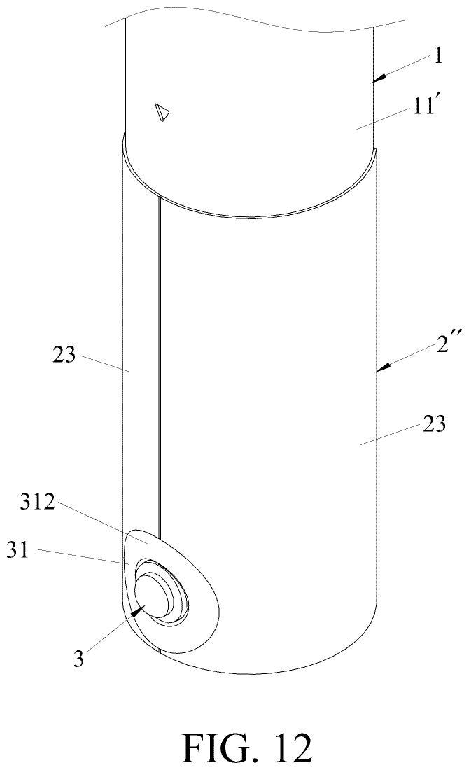

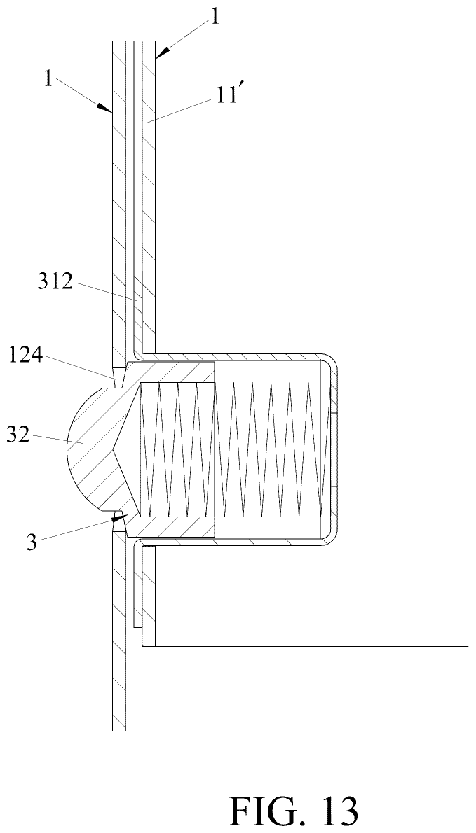

FIGS. 12 and 13 illustrate a telescopic flagpole according to a third embodiment of the disclosure, which has a structure generally slimier to that of the first embodiment. However, in this embodiment, the resistance member 2″ of each of the fastening units 20 is composed of two impediment pieces 23 that are spaced apart from each other and that are adhesively fixed to the respective general lower end portion 11′ away from the he abutment portion 312 of the fastening body 31. Each of the impediment pieces 23 has a semi-circular notch. The semi-circular notches of the impediment pieces 23 surround the abutment portion 312 of the fastening body 31, and an outer surface of the abutment portion 312 of the fastening body 31 dose not protrude outwardly of an outer surface of each of the impediment pieces 23. In this embodiment, the abutment portion 312 of the fastening body 31 is directly mounted to the respective general lower end portion 11′ and is spaced apart from an outer one of the respective adjacent pair of the tubular members 1. As a result, the telescopic flagpole of the third embodiment may achieve the same effect as the telescopic flagpole of the second embodiment, where the frictional contact between the abutment portion 312 of the fastening body 31 and the outer one of the respective adjacent pair of the tubular members 1 is prevented.

It should be noted that, in other variant embodiments, the resistance member 2″ of each of the fastening units 20 may be composed of more than three spaced apart impediment pieces 23 each being adhesively fixed to the respective general lower end portion 11′.

To sum up, the telescopic flagpole of the disclosure has the following advantages.
1. Because the resistance member 2, 2′, 2″ of each of the fastening units 20 is disposed between the respective adjacent pair of the tubular members 1, the friction between the respective adjacent pair of the tubular members 1 is increased to reduce a relative movement speed between the respective adjacent pair of the tubular members 1. As a result, when the tubular members 1 of the respective adjacent pair of the tubular members 1 are moved away from each other to the greatest extent, they are impeded to slide relative to each other, thereby facilitating the resilient fastening mechanism 3 mounted to one of the respective adjacent pair of the tubular members 1 to be oriented to the upper through hole 124 of the general upper end portion 12′ of the other one of the respective adjacent pair of the tubular members 1. When the respective adjacent pair of the tubular members 1 are moved away from each other to the greatest extent, because the resistance member 2, 2′, 2″ of each of the fastening units 20 abuts against the general lower end portion 11′ of one of the respective adjacent pair of the tubular members 1 and the general upper end portion 12′ of the other one of the respective adjacent pair of the tubular members 1, the relative movement of the respective adjacent pair of the tubular members 1 is limited along the vertical direction (Z), and the fastening protrusion 32 of the resilient fastening mechanism 3 mounted to one of the respective adjacent pair of the tubular members 1 and the upper through hole 124 of the other one of the respective adjacent pair of the tubular members 1 are located on a same horizontal plane. In case where the fastening protrusion 32 of the resilient fastening mechanism 3 mounted to one of the respective adjacent pair of the tubular members 1 is not aligned with the upper through hole 124 of the other one of the respective adjacent pair of the tubular members 1, rotating one of the respective adjacent pair of the tubular members 1 relative to the other one of the respective adjacent pair of the tubular members 1 may cause the fastening protrusion 32 to protrude outwardly from the upper through hole 124.
2. Because the resistance member 2, 2′, 2″ of each of the fastening units 20 partially surrounds the inner one of the respective adjacent pair of the tubular members 1 and resiliently abuts against the outer one of the respective adjacent pair of the tubular members 1 in a relatively large section, the friction between the respective adjacent pair of the tubular members 1 is increased.
3. During retraction of the telescopic flagpole of the disclosure, the blocking member 4 prevents the general lower end portions 11′ from hitting the fastening bodies 31 of the fastening units 20, thereby increasing the service life of the telescopic flagpole of the disclosure.
4. The telescopic flagpole of the disclosure is simple in structure and may be conveniently maintained. When the screw 43 is removed, the blocking member 4 may be detached from the flagpole bottom end portion 13 to sequentially disassemble the tubular members 1 for checking the resistance member 2, 2′, 2″ and the resilient fastening mechanism 3 of each of the fastening units 20, thereby facilitating repair and maintenance of the telescopic flagpole. In addition, the resistance members 2, 2′, 2″ of each of the fastening units 20 are not exposed on the outer one of the respective adjacent pair of the tubular members 1, so the telescopic flagpole is simple and aesthetically pleasing in appearance.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A telescopic flagpole, comprising:
at least two tubular members surrounding an axis that is substantially vertical, and telescopically connected to each other, each of said at least two tubular members having a lower end portion and an upper end portion opposite to said lower end portion,
said lower end portion of an outermost one of said at least two tubular members being designated as a flagpole bottom end portion of said telescopic flagpole, said lower end portion of each of a remainder of said at least two tubular members being designated as a general lower end portion,
said upper end portion of an innermost one of said at least two tubular members being designated as a flagpole top end portion of said telescopic flagpole, said upper end portion of each of the remainder of said at least two tubular members being designated as a general upper end portion and being formed with an upper through hole that extends perpendicularly to said axis; and
at least one fastening unit each being disposed between a respective adjacent pair of said at least two tubular members, and including
a resistance member that is disposed between and abuts against the respective adjacent pair of said at least two tubular members to increase friction between the respective adjacent pair of said at least two tubular members, and
a resilient fastening mechanism that is mounted to a respective general lower end portion, and that includes a fastening protrusion being resiliently and radially movable;
wherein said telescopic flagpole is convertible between a retracted state and a fixed state;
wherein, when said telescopic flagpole is in the retracted state, said fastening protrusion of each of said at least one fastening unit resiliently abuts against an inner surface of an outer one of the respective adjacent pair of said at least two tubular members; and
wherein, when said telescopic flagpole is in the fixed state, said resistance member of each of said at least one fastening unit is disposed between and abuts against said general lower end portion of one of the respective adjacent pair of said at least two tubular members and said general upper end portion of another one of the respective adjacent pair of said at least two tubular members, and said fastening protrusion of each of said at least one fastening unit protrudes outwardly from said upper through hole of said general upper end portion of said another one of the respective adjacent pair of said at least two tubular members.

2. The telescopic flagpole as claimed in claim 1, wherein:
said resistance member of each of said at least one fastening unit partially surrounds an inner one of the respective adjacent pair of said at least two tubular members, and resiliently abuts against the respective adjacent pair of said at least two tubular members;
said resistance member of each of said at least one fastening unit has a lower resistance portion and an upper resistance portion opposite to said lower resistance portion along said axis; and
when said telescopic flagpole is in the fixed state, said lower resistance portion of said resistance member of each of said at least one fastening unit abuts against said general lower end portion of said one of the respective adjacent pair of said at least two tubular members, and said upper resistance portion of said resistance member of each of said at least one fastening unit abuts against said general upper end portion of said another one of the respective adjacent pair of said at least two tubular members.

3. The telescopic flagpole as claimed in claim 2, wherein said resistance member of each of said at least one fastening unit is secured on said general lower end portion of said one of the respective adjacent pair of said at least two tubular members.

4. The telescopic flagpole as claimed in claim 3, wherein:
each general lower end portion is formed with a lower through hole extending perpendicularly to said axis;
said lower resistance portion of said resistance member of each of said at least one fastening unit has an open hole aligned with said lower through hole of a respective general lower end portion; and
said resilient fastening mechanism of each of said at least one fastening unit further includes
a fastening body mounted to said respective general lower end portion and extending through said lower through hole of said respective general lower end portion and said open hole of said resistance member of said at least one fastening unit, and
a resilient member disposed between said fastening body and said fastening protrusion.

5. The telescopic flagpole as claimed in claim 4, wherein:
said fastening body of each of said at least one fastening unit has
a casing portion that extends through said lower through hole of said respective general lower end portion and said open hole of said resistance member of said at least one fastening unit, that defines a receiving space, and that has a casing open end and a casing close end opposite to said casing open end, and
an abutment portion that is connected to said casing open end of said casing portion and that abuts against said resistance member of said at least one fastening unit; and
said resilient member is disposed in said receiving space, and abuts against said casing close end of said casing portion.

6. The telescopic flagpole as claimed in claim 1, wherein:
said flagpole bottom end portion has a bottom end surface;
said telescopic flagpole further comprises a blocking member that is disposed in said flagpole bottom end portion; and
when said telescopic flagpole is in the retracted state, each general lower end portion abuts against said blocking member and is spaced apart from said bottom end surface.

7. The telescopic flagpole as claimed in claim 6, wherein:
said at least two tubular members includes at least three tubular members, each general lower end portion being formed with a lower through hole extending perpendicularly to said axis;
said at least one fastening unit includes at least two fastening units;
said resilient fastening mechanism of each of said at least one fastening unit further includes
a fastening body mounted to said respective general lower end portion and extending through said lower through hole of said respective general lower end portion, and
a resilient member disposed between said fastening body and said fastening protrusion; and
when said telescopic flagpole is in the retracted state, each general lower end portion abuts against said blocking member and is spaced apart from said bottom end surface.

8. The telescopic flagpole as claimed in claim 7, wherein:
said blocking member has a main body portion and a plurality of blocking portions that extend from said main body portion away from said axis;
a number of said blocking portions is equal to a number of said lower tubular portions;
a distance between a lower one of said blocking portions and said axis is greater than a distance between an upper one of said blocking portions and said axis;
projections of each of said blocking portions on an imaginary plane coplanar with said bottom end surface respectively overlap projections of said general lower end portions on the imaginary plane; and
when said telescopic flagpole is in the retracted state, said general lower end portions respectively abut against said blocking portions.

9. The telescopic flagpole as claimed in claim 8, wherein:
said blocking member is arc shaped that has an outer contour in conformity with an inner contour of said flagpole bottom end portion; and
said blocking portions of said blocking member are arranged in a stairstep configuration.

10. The telescopic flagpole as claimed in claim 1, wherein:
each general upper end portion has
a tube segment that is formed with said upper through hole, and
an open segment that is connected to a top end of said tube segment and that has an internal width gradually decreases upwardly; and
when said telescopic flagpole is in the fixed state, said resistance member of each of said at least one fastening unit is disposed between and abuts against said general lower end portion of one of the respective adjacent pair of said at least two tubular members and said open segment of said general upper end portion of another one of the respective adjacent pair of said at least two tubular members.

11. The telescopic flagpole as claimed in claim 1, wherein:
each general lower end portion is formed with a first external anchoring index;
each general upper end portion is formed with a second external anchoring index that is disposed above said upper through hole; and
when said telescopic flagpole is in the fixed state, for each adjacent pair of said at least two tubular members, said first external anchoring index of one of said adjacent pair of said at least two tubular members and said second anchoring index of another one of said adjacent pair of said at least two tubular members are substantially aligned with each other in a direction of said axis.

12. The telescopic flagpole as claimed in claim 1, wherein, said resilient fastening mechanism of each of said at least one fastening unit further includes
a fastening body that is mounted to said respective general lower end portion and that is spaced apart from an outer one of the respective adjacent pair of said at least two tubular members, and
a resilient member that is disposed between said fastening body and said fastening protrusion.
